(19) United States
(12) Patent Application Publication
(10) Pub. No.: US 2022/0279102 A1
(43) Pub. Date: Sep. 1, 2022

(54) CAMERA MODULE AND CAMERA-MODULE-ATTACHED ELECTRONIC DEVICE

(71) Applicant: Lenovo (Singapore) Pte. Ltd., Singapore (SG)

(72) Inventors: Yuichi Onda, Kanagawa (JP); Seita Horikoshi, Kanagawa (JP); Kenji Watamura, Kanagawa (JP)

(73) Assignee: Lenovo (Singapore) Pte. Ltd., Singapore (SG)

(21) Appl. No.: 17/581,138

(22) Filed: Jan. 21, 2022

(30) Foreign Application Priority Data
Feb. 26, 2021 (JP) 2021-030433

(51) Int. Cl. H04N 5/225

(52) U.S. Cl. CPC H04N 5/2257; H04N 5/2252

(57) ABSTRACT

A camera module includes an imaging element, a main body unit that houses the imaging element and has a downward-facing installation surface, a plurality of conduction pins, protruding from the installation surface downward, that are biased downward in an upward movable state and are disposed side by side in a crosswise direction, and at least one fixing member. In a case where a direction that is orthogonal to both a vertical direction and the crosswise direction is defined as a depth direction, the side that the imaging element faces in the depth direction is defined as the imaging side and the side that is opposite to the imaging side is defined as a non-imaging side. The main body unit has a guide section that is disposed closer to the imaging side than the plurality of conduction pins and protrudes from the installation surface downward.

### CROSS-REFERENCE TO RELATED APPLICATIONS

This application claims priority to Japanese Patent Application No. 2021-30433 filed Feb. 26, 2021, the contents of which are hereby incorporated herein by reference in their entirety.

### TECHNICAL FIELD

The present invention relates to a camera module and a camera-module-attached electronic device.

### BACKGROUND

Hitherto, a camera module built-in PC (Personal Computer) such as the camera module built-in PC which is disclosed in, for example, Japanese Patent No. 5197822 has been known. This camera module built-in PC includes a display chassis and a camera module which is housed in the display chassis.

### SUMMARY

Incidentally, in general, when high-precision of the camera module is realized, the size of the camera module is inevitably increased with realization of the high-precision of the camera module. For example, in a case of trying to realize the high-precision of the camera module in the camera module built-in PC which is disclosed in Japanese Patent No. 5197822, a depth-direction thickness of the display chassis and a vertical-direction width of a frame (a vessel) which surrounds a display are increased with realization of the high-precision of the camera module.

One or more embodiments of the present invention relate to a camera module and a camera-module-attached electronic device which make it possible to suppress increases in depth-direction thickness of the display chassis and vertical-direction width of the frame (the vessel) even in a case where the high-precision of the camera module is realized.

In one or more embodiments of the present invention, a camera module includes an imaging element, a main body unit which houses the imaging element and has a downward-facing installation surface, a plurality of conduction pins which protrudes from the installation surface downward, is biased downward in an upward movable state and is arranged side by side in a crosswise direction and at least one fixing member, in which in a case where a direction which is orthogonal to both a vertical direction and the crosswise direction is defined as a depth direction, the side that the imaging element faces in the depth direction is defined as the imaging side and the side which is opposite to the imaging side is defined as the non-imaging side, the main body unit has a guide section which is arranged closer to the non-imaging side than the plurality of conduction pins and protrudes from the installation surface downward and the guide section has a guide surface which faces the imaging side.

It is possible to attach the camera module according to one or more embodiments of the present invention to the electronic device from the outside. Thereby, it becomes possible to suppress increases in depth-direction thickness of the display chassis and vertical-direction width of the frame even in a case where the high-precision of the camera module is realized in comparison with a case where the camera module is built in the electronic device.

In addition, in the camera module according to one or more embodiments of the present invention, since the conduction pins are biased downward in the upward movable state, it becomes possible to electrically connect the electronic device with the imaging element by pressing the conduction pins against conduction pads which are installed on the electronic device. In addition, since at least one fixing member is arranged, it becomes possible to stably fix the camera module and the electronic device together. Further, owing to provision of the guide section which protrudes from the installation surface downward on the main body unit, it becomes possible for a user to define an attachment position with ease by placing the guide section along a display surface or a back surface of the electronic device when attaching the cameral module to the electronic device. In addition, in a case where external force acts on the electronic device in a state where the camera module is attached to the electronic device, the guide section receives the external force and thereby it becomes possible to suppress sudden falling of the camera module.

Here, in the plurality of conduction pins, the conduction pins which are arranged at mutually symmetric positions in the crosswise direction may have the mutually same functions.

In this case, even when the camera module is attached to the electronic device such that the imaging element faces either the display surface side or the back surface side of the electronic device, the function that each conduction pin has is not changed when seen from the electronic device side. Accordingly, it becomes possible to reverse an imaging direction with ease simply by attaching the camera module to the electronic device by turning the cameral module 180 degrees around a vertical-direction axis.

In addition, a cameral-module-attached electronic apparatus according to one or more embodiments of the present invention includes an electronic device which has a display chassis and a camera module which is configured to be detachable relative to the electronic device and has an imaging element, in which the electronic device includes a pad unit which is exposed to an upper surface of the display chassis and that a plurality of conduction pads is arranged side by side in a crosswise direction, and at least one device-side fixing member, the camera module includes a main body unit which houses the imaging element and has a downward-facing installation surface, a plurality of conduction pins which protrudes from the installation surface downward, is biased downward in an upward-movable state and is arranged side by side in the crosswise direction, and at least one fixing member which engages with the device-side fixing member, in a case where a direction which is orthogonal to both a vertical direction and the crosswise direction is defined as a depth direction, the side that the imaging element faces in the depth direction is defined as the imaging side and the side which is opposite to the imaging side is defined as the non-imaging side, the main body unit has a guide section which is arranged closer to the non-imaging side than the plurality of conduction pins and protrudes from the installation surface downward, the guide section has a guide surface which faces the imaging side, and a thickness of the display chassis in the depth direction is almost twice a mean value of a distance which is measured from a central axis line of each of the plurality of conduction pins to the guide surface in the depth direction.

In the camera-module-attached electronic device according to one or more embodiments of the present invention, it becomes possible to suppress the increases in depth-direction thickness of the display chassis and vertical-direction width of the frame even in a case where the high-precision of the camera module is realized as described above. In addition, it becomes possible to attach the camera module to the electronic device with ease owing to engagement of the fixing member with the device-side fixing member.

Further, the depth-direction thickness of the display chassis is almost twice the mean value of the distance which is measured from the central axis line of each of the plurality of conduction pins to the guide surface. Thereby, it becomes possible to maintain the distance between the guide section and the display chassis almost constant even in a case where the camera module is attached to the electronic device in such a manner that the imaging element faces either the display surface side or the back surface side of the electronic device. Accordingly, it becomes possible to make the guide section function irrespective of an attachment posture of the camera module.

Here, the display chassis may have a display and a vessel which surrounds the display and is at least partially made of metal, each of the conduction pads may have a shaft section which extends in the vertical direction and a head section which is located on an upper end of the shaft section and is larger than the shaft section in area when seen in a planar view, an insulation sheet may be arranged between the head section and the vessel and part of the shaft section may be covered with an insulation tube.

In this case, it becomes possible to electrically insulate a circuit system which is configured by the imaging element, a substrate in the display chassis and so forth from a metal portion of the vessel. Thereby, it becomes possible to suppress intrusion of, for example, static electricity, noises and so forth into the circuit system via the vessel.

In addition, an insulation section (the insulation sheet and the insulation tube) and the conduction pads are formed separately from each other. Accordingly, it becomes easy to make the insulation section (the insulation sheet and the insulation tube) thin in comparison with, for example, a case where each conduction pad and the insulation section are integrally formed by insert molding and so forth. Thereby, it becomes possible to suppress an increase in depth-direction thickness of the display chassis which is induced by an increase in thickness of the insulation section.

The above-described embodiments of the present invention can provide the camera module and the camera-module-attached electronic device which make it possible to suppress the increase in depth-direction thickness of the display chassis even in a case where the high-precision of the camera module is realized.

### BRIEF DESCRIPTION OF THE DRAWINGS

FIG. 1 is an overall perspective view illustrating one example of a camera-module-attached electronic device according to another embodiment of the present invention.

FIG. 2 is a perspective view illustrating one example of a camera module according to one embodiment of the present invention.

FIG. 3 is a diagram when seen in a direction of a III arrow in FIG. 2.

FIG. 4 is a sectional arrow view taken along the IV-IV line in FIG. 3.

FIG. 5 is a perspective view illustrating one example of a situation where the camera module is about to be attached to the electronic device.

FIG. 6 is a sectional arrow view taken along the VI-VI line in FIG. 1.

FIG. 7 is a sectional arrow view taken along the VII-VII line in FIG. 6

FIG. 8 is a diagram illustrating one example of a state where an attachment posture of the camera module in FIG. 7 is turned.

### DETAILED DESCRIPTION

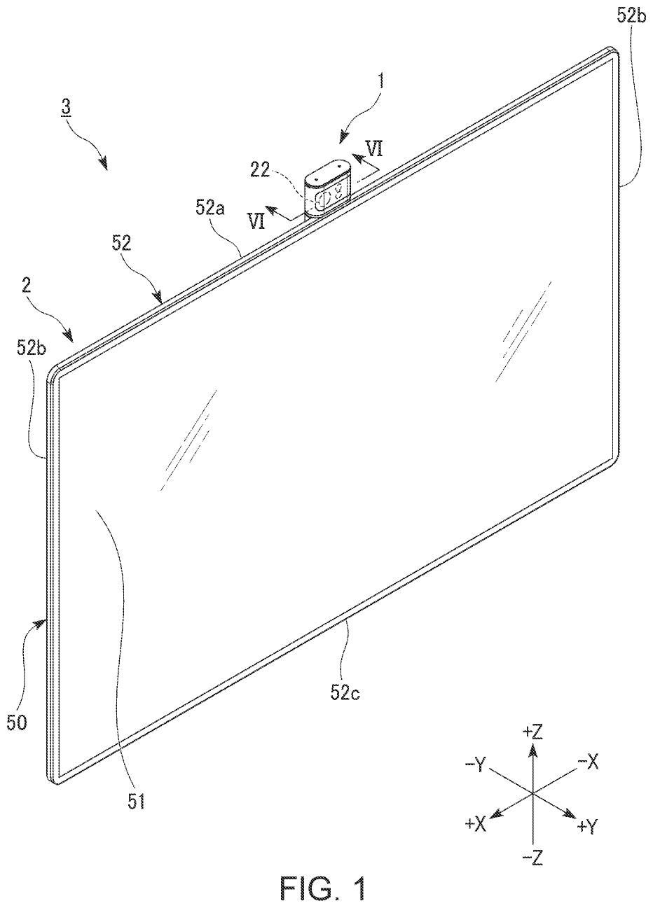

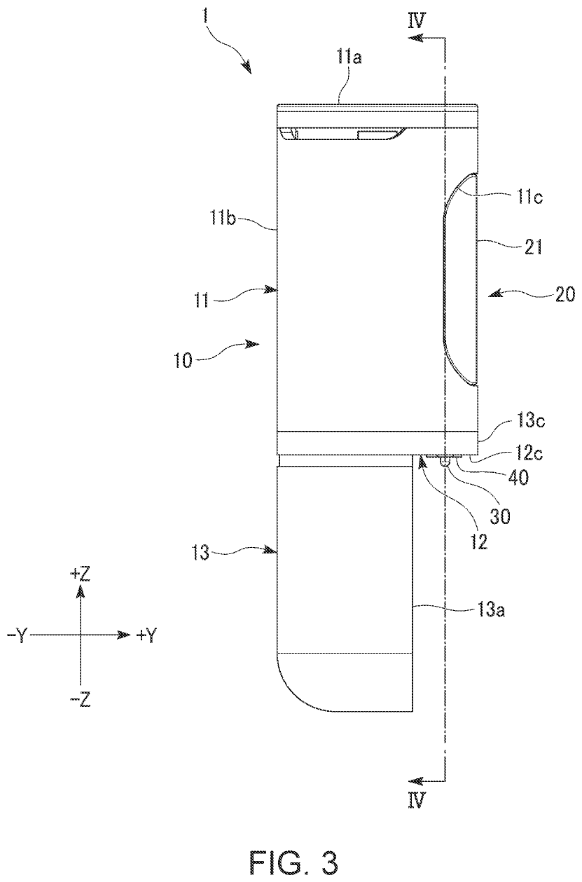

In the following, a camera-module-attached electronic device and a camera module which is to be attached to the electronic device according to embodiments of the present invention will be described on the basis of FIG. 1 to FIG. 8.

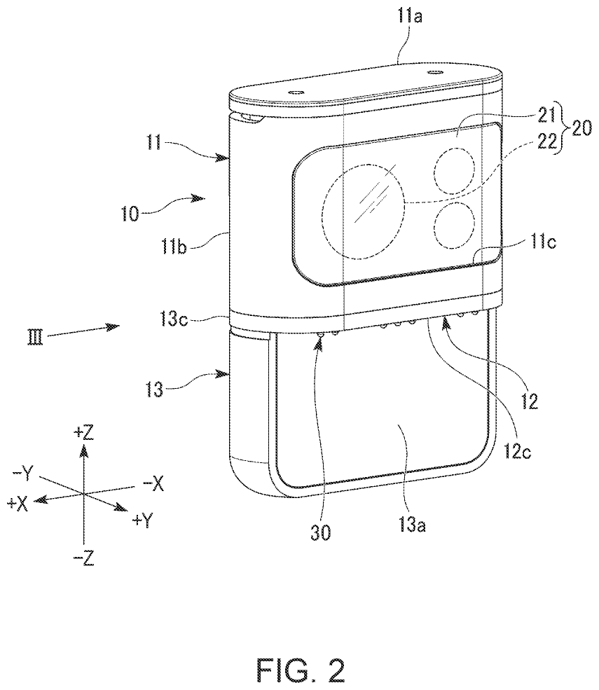

As illustrated in FIG. 1, a camera-module-attached electronic device 3 includes an electronic device 2 which has a display chassis 50 and a camera module 1 which has an imaging element 22. The camera module 1 is configured to be attachable/detachable to/from one side of the sheet-shaped display chassis 50. As illustrated in FIG. 2, the camera module 1 includes a plurality of conduction pins 30 which serves as an interface for electric connection with the electronic device 2.

Incidentally, although the electronic device 2 which is illustrated in FIG. 1 is a so-called tablet terminal, other kinds of electronic devices may be adopted as the electronic device 2. For example, the electronic device 2 may be a clamshell-shaped PC (Personal Computer), a smartphone, a gaming machine and so forth. In a case where the electronic device 2 is the clamshell-shaped PC, a second chassis is connected to the display chassis 50 via hinges. A keyboard, a mother board and so forth are installed on the second chassis.

### Definition of Directions

Here, in the embodiments of the present invention, positional relations between/among respective constitutional elements will be described by setting an XYZ orthogonal coordinate system. In the following, a direction that the plurality of conduction pins 30 is arranged side by side will be called a crosswise direction X and is plotted as the X-axis in the drawings. A direction that each conduction pin 30 extends will be called a vertical direction Z and is plotted as the Z-axis in the drawings. A direction which is orthogonal to both the crosswise direction X and the vertical direction Z will be called a depth direction Y and is plotted as the Y-axis in the drawings. In the vertical direction Z, the camera module 1 side (the +Z side) will be called the upward side and the electronic device 2 side (the −Z side) will be called the downward side. In the depth direction Y, the side (the +Y side) that the imaging element 22 faces will be called the imaging side and the side (the −Y side) which is opposite to the imaging side will be called the non-imaging side. A view which is seen in the vertical direction Z will be called a planar view.

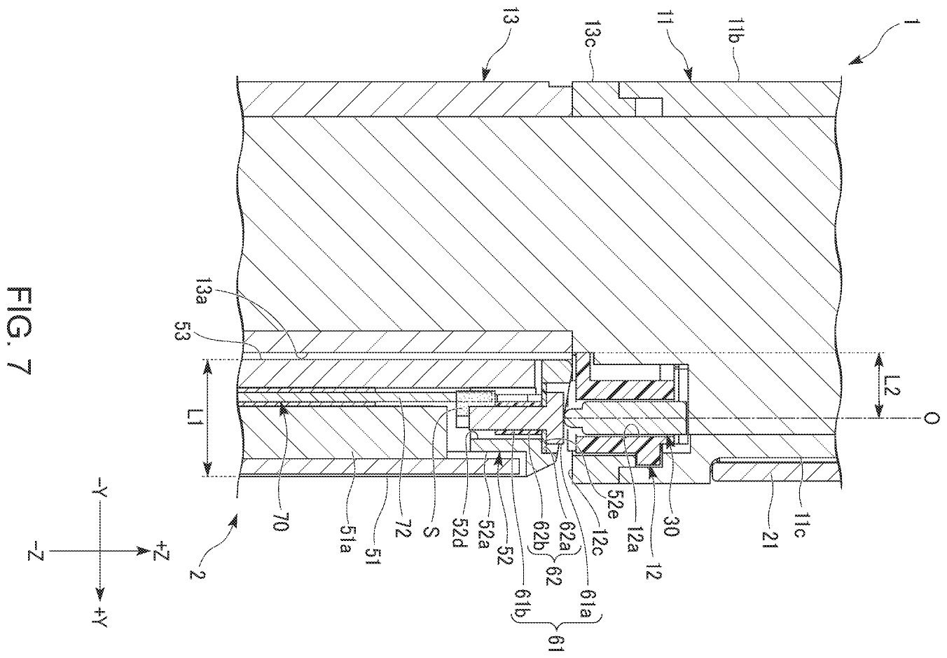

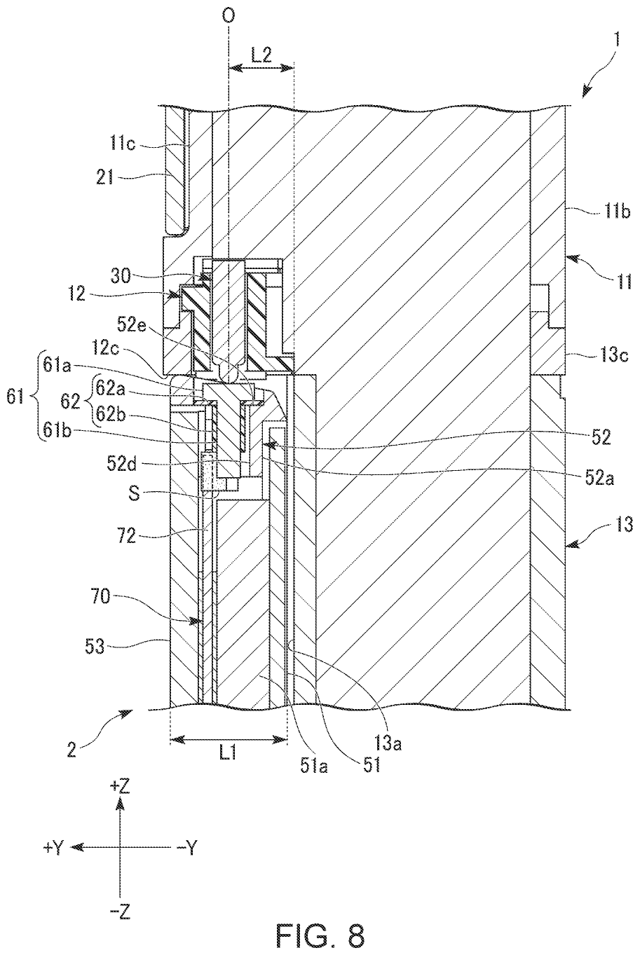

The camera module 1 would take two attachment postures, that is, a first posture and a second posture, relative to the electronic device 2. The first posture is the attachment posture that a direction (the display surface side) that a display 51 of the display chassis 50 faces matches the imaging side (see FIG. 1 and FIG. 7). The second posture is the attachment posture that a direction (the back surface side) which is opposite to the direction that the display 51 faces matches the imaging side (see FIG. 8). In the following, the positional relations between/among the respective constitutional elements in a case where the camera module 1 takes the first posture will be described unless otherwise specified.

### (Camera Module)

As illustrated in FIG. 2 to FIG. 4 and so forth, the camera module 1 includes a main body unit 10, an imaging unit 20 which is housed in the main body unit 10, the plurality of conduction pins 30 and at least one fixing member 40. In one embodiment of the present invention, although the number of the conduction pins 30 is seven and the number of the fixing members 40 is two, these numbers may be appropriately changed.

The main body unit 10 has a housing section 11, an installation section 12 and a guide section 13. The imaging element 22 is housed in the housing section 11. The installation section 12 is disposed on a lower end of the housing section 11. The guide section 13 protrudes from the lower end of the housing section 11 downward. The installation section 12 is arranged closer to the imaging side (the +Y side) than the guide section 13.

The housing section 11 has a cylindrical case 11b which extends in the vertical direction Z and a top wall 11a which closes an upper end of the case 11b. The case 11b is formed into an elliptical shape which is longer in the crosswise direction X than in the depth direction Y when seen in the vertical direction Z. An imaging hole 11c into which an imaging window 21 (will be described later) in the imaging unit 20 is fitted is formed in the case 11b. The imaging hole 11c is formed to pass through a face which faces the imaging side in the depth direction Y in the case 11b.

The guide section 13 has a guide surface 13a which faces the imaging side. The guide surface 13a is a flat surface which extends along the vertical direction Z and the crosswise direction X. The guide section 13 is connected to the housing section 11 by an annular connection portion 13c. The connection portion 13c is disposed on a lower end of the case 11b of the housing section 11 and also serves to support the installation section 12.

The installation section 12 has a plurality of conduction pin holes 12a and a plurality of first holding portions 12b. The plurality of conduction pin holes 12a is arranged side by side in the crosswise direction X and extends along the vertical direction Z. The plurality of first holding portions 12b serves to hold the fixing member 40 which will be described later. The installation section 12 has a downward-facing installation surface 12c. The installation surface 12c abuts on or comes close to the electronic device 2 (more specifically, an upper vessel section 52a) when the cameral module 1 is attached to the electronic device 2.

The imaging unit 20 has the imaging window 21 which is fitted into the imaging hole 11c in the main body unit 10 and an imaging element 22. The imaging window 21 is formed by a transparent member. The imaging element 22 has a function of converting light to an electric signal (image data). It is possible to adopt an RGB camera and an infrared-ray camera as the imaging element 22.

The plurality of conduction pins 30 is inserted into the plurality of conduction pin holes 12a in one-to-one correspondence. In one embodiment of the present invention, a so-called pogo pin is adopted as each conduction pin 30. Specifically, each conduction pin 30 is biased downward in an upward movable state. At least some conduction pins 30 are electrically connected with the imaging element 22. A lower end of each conduction pin 30 protrudes downward beyond the installation surface 12c. The plurality of conduction pins 30 is arranged side by side in the crosswise direction X and extends along the vertical direction Z.

Here, the mutually mating conduction pins 30 which are arranged at mutually symmetric positions in the crosswise direction X have the mutually same functions.

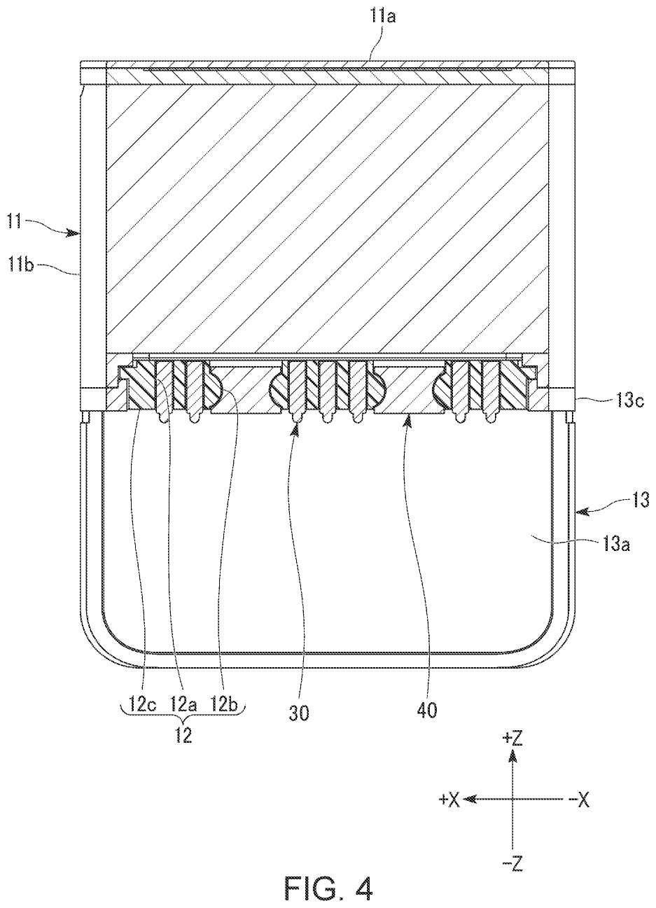

In one embodiment of the present invention, seven conduction pins 30 are arranged and it is possible for the seven conduction pins 30 to transmit and receive electric signals which conform to the USB (Universal Serial Bus) standards. In general, at least four kinds of paths such as V_BUS and GND (used for a power source), and D+ and D− (used for data) are used for transmission and reception of the electric signals which conform to the USB standards. In one embodiment of the present invention, the seven conduction pins 30 in FIG. 4 are used for transmission and reception of the electric signals through the paths V_BUS, GND, D−, D+, D−, GND, and V_BUS which are arrayed in order from the left of a paper surface. The mutually mating conduction pins 30 which are arranged at the mutually symmetric positions in the crosswise direction X in this way have the mutually same functions and thereby a signal constellation which is seen from the electronic device 2 side becomes constant irrespective of the attachment posture of the camera module 1. Incidentally, the above-described signal constellation is merely one example and may be appropriately changed.

The fixing members 40 engage with device-side fixing members 80 which will be described later in one-to-one correspondence and thereby fix the camera module 1 to the electronic device 2. It is possible to adopt, for example, permanent magnets, iron and so forth as materials of the fixing members 40 and the device-side fixing members 80. In this case, the camera module 1 is fixed to the electronic device 2 with the aid of magnetic force which is generated between the mutually mating fixing members 40 and device-side fixing members 80. Here, more specifically, in a case where the device-side fixing members 80 are composed of the permanent magnets, the fixing members 40 may be either made of iron or composed of the permanent magnets. Likewise, in a case where the fixing members 40 are composed of the permanent magnets, the device-side fixing members 80 may be either made of iron or composed of the permanent magnets.

In one embodiment of the present invention, the permanent magnets are used for both the fixing members 40 and the device-side fixing members 80. In addition, the respective permanent magnets which are used for the fixing members 40 are arranged in such a manner that the N poles thereof face outward in the crosswise direction X and the S poles thereof face inward in the crosswise direction X. On the other hand, the respective permanent magnets which are used for the device-side fixing members 80 are arranged in such a manner that the N poles thereof face inward in the crosswise direction X and the S poles thereof face outward in the crosswise direction X. When attaching the camera module 1 to the electronic device 2, it becomes possible to readily define relative positions of the both in the crosswise direction X by arranging the polarities of the permanent magnets in this way. In addition, polarity arrangements of the both are bilaterally symmetric to each other as a whole and therefore it becomes possible to obtain the effect which is the same as the above irrespective of the attachment posture of the camera module 1. Incidentally, the above-mentioned polarity arrangements are merely one example. So long as the suction force works between the mutually mating fixing members 40 and device-side fixing members 80 and the polarity arrangements of the both are bilaterally symmetric to each other as a whole, it is possible to obtain the effect which is the same as the above also in a case of using other polarity arrangements.

Each fixing member 40 is held in the installation section 12 by each first holding portion 12b. The fixing members 40 are arranged in the vicinity of the installation surface 12c so as to generate the magnetic force for holding the camera module 1 in cooperation with the corresponding device-side fixing members 80. Specifically, in one embodiment of the present invention, each of the two fixing members 40 is arranged between the mutually different conduction pins 30. However, the fixing members 40 may be arranged on the outer sides of the plurality of conduction pins 30 in the crosswise direction X.

### (Electronic Device)

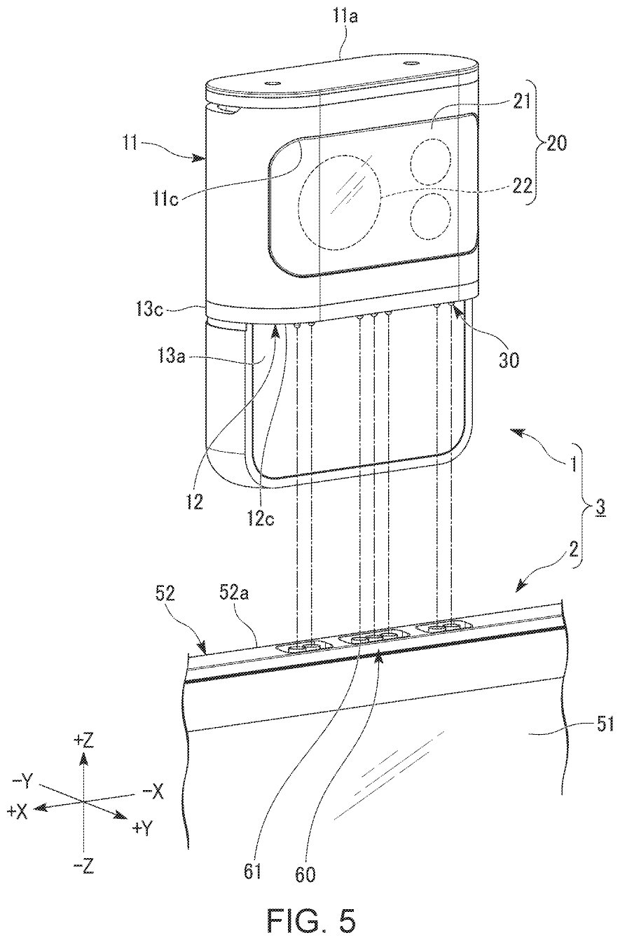

As illustrated in FIG. 5 to FIG. 7, the electronic device 2 includes the display chassis 50, a pad unit 60, an FPC (Flexible Printed Circuit) 70 which is housed in the display chassis 50 and at least one device-side fixing member 80.

As illustrated in FIG. 1 and FIG. 7, the display chassis 50 includes the display 51, a rectangular metal vessel 52 which surrounds the display 51 and a rear plate section 53 which covers an opposite-side surface of the display 51. It is possible to adopt an OLED (Organic Light Emitting Diode) display, a liquid crystal display and so forth as the display 51. A control section 51a which controls display on a screen of the display 51 is disposed on a rear surface of the display 51.

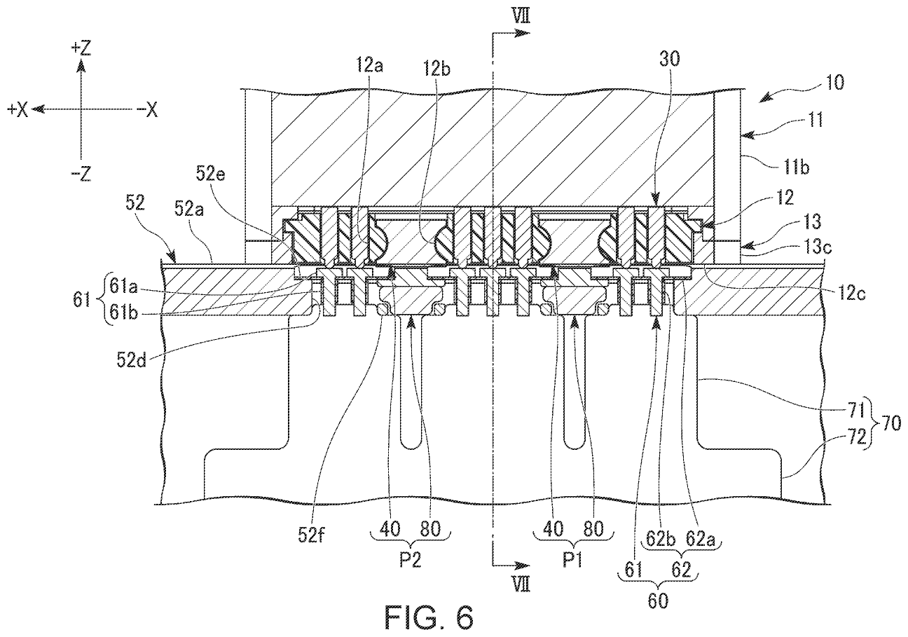

As illustrated in FIG. 1, the vessel 52 has the upper vessel section 52a, two lateral vessel sections 52b which extend downward from left and right ends of the upper vessel section 52a and a lower vessel section 52c which connects lower ends of the two lateral vessel sections 52b together and is arranged in parallel with the upper vessel section 52a. The upper vessel section 52a and the lower vessel section 52c are arranged in parallel with each other in the crosswise direction X and the two lateral vessel sections 52b are arranged in parallel with each other in the vertical direction Z. As illustrated in FIG. 6, a pad hole 52d in which the pad unit 60 is disposed is formed in the upper vessel section 52a.

The pad hole 52d is formed to pass through the upper vessel section 52a in the vertical direction Z. Pad holding sections 52e are formed in the pad hole 52d. In addition, in the upper vessel section 52a, a second holding section 52f which holds each device-side fixing member 80 is disposed in the vicinity of the pad hole 52d.

The pad unit 60 includes a plurality of conduction pads 61 which is arranged side by side in the crosswise direction X and an insulation section 62 which insulates the respective conduction pads 61 from the vessel 52. The pad unit 60 is held by the pad holding sections 52e. A central axis line of each of the plurality of conduction pads 61 is arranged so as to match the center of the display chassis 50 in the depth direction Y.

As illustrated in FIG. 6, each conduction pad 61 has a shaft section 61b which extends in the vertical direction Z and a head section 61a which is located on an upper end of the shaft section 61b. In a planar view, the head section 61a is larger than the shaft section 61b in area. Each head section 61a is exposed to the outside through the pad hole 52d. All the central axis lines of the respective shaft sections 61b are located almost at the center of the upper vessel section 52a in the depth direction Y (see FIG. 7). The insulation section 62 has insulation sheets 62a which abut on lower surfaces of the respective head sections 61a and insulation tubes 62b which partially cover the respective shaft sections 61b. A through hole into which the shaft section 61b of each conduction pad 61 is to be inserted is formed in each insulation sheet 62a. Each conduction pad 61 is electrically insulated from the upper vessel section 52a by each insulation sheet 62a and each insulation tube 62b. In one embodiment of the present invention, the number of the insulation sheets 62a and the number of the pad holding sections 52e are three respectively. Each pad holding section 52e holds each insulation sheet 62a from below. Three conduction pads 61 are inserted into the insulation sheet 62a which is located at the center in the crosswise direction X. Every two conduction pads 61 are inserted into each of two insulation sheets 62a which are located on the outer sides in the crosswise direction X.

As described above, each insulation section 62 (each insulation sheet 62a and each insulation tube 62b) and each conduction pad 61 are formed separately from each other. For this reason, it becomes easy to make the insulation sheets 62a and the insulation tubes 62b thin in comparison with a case where each conduction pad 61 and each insulation section 62 are integrally formed by, for example, insert molding and so forth. Thereby, it becomes possible to suppress an increase in size of the upper vessel section 52a which has the insulation sections 62.

As illustrated in FIG. 6, the FPC 70 has a base section 71 and three protruding sections 72 which protrude from the base section 71 upward. As illustrated in FIG. 7, the plurality of conduction pads 61 is electrically connected to upper ends of the protruding sections 72 with solder S. Describing in more details, a lower end portion of the shaft section 61b of each conduction pad 61 protrudes from each insulation tube 62b downward. The lower end portion of each shaft section 61b is fixed to each protruding section 72 with the solder S.

As illustrated in FIG. 6, at least one device-side fixing member 80 is disposed in the upper vessel section 52a. In one embodiment of the present invention, two device-side fixing members 80 are arranged in a state of leaving a space between the two device-side fixing members 80 in correspondence with the fixing members 40 on the camera module 1 side. The device-side fixing members 80 are held in the vicinity of the pad units 60 by the second holding sections 52f respectively. It is possible to appropriately change the position of each device-side fixing member 80 on condition that it is possible to generate the magnetic force between each device-side fixing member 80 and each fixing member 40 in the vicinity of each pad unit 60.

### (Camera-Module-Attached Electronic Device)

As illustrated in FIG. 6, a camera-module-attached electronic device 3 according to another embodiment of the present invention has two suction areas P1 and P2. The suction areas P1 and P2 are arranged in a state of leaving a space between the suction areas P1 and P2 in the crosswise direction X. Each of the suction areas P1 and P2 includes each fixing member 40 and each device-side fixing member 80 which are sucked together with the magnetic force. Owing to this configuration, it is possible to fix the camera module 1 to the electronic device 2 with the magnetic force.

In addition, the plurality of conduction pins 30 and the plurality of conduction pads 61 are disposed in such a manner that each conduction pin 30 and each conduction pad 61 mutually confront in the vertical direction Z. Since a lower end of each conduction pin 30 is located below the installation surface 12c, in a case where each installation section 12 and the upper vessel portion 52a are brought closer to each other, the lower end of each conduction pin 30 is pressed against each conduction pad 61. Thereby, it becomes possible to electrically connect each conduction pin 30 and each conduction pad 61 together.

As illustrated in FIG. 7, in the specification, a thickness (the size in the depth direction Y) of the display chassis 50 is denoted by L1. In addition, a mean value of a distance which is measured from a central axis line O of the plurality of conduction pins 30 to the guide surface 13a in the depth direction Y is denoted by L2. The size L1 is almost twice the size L2. Incidentally, “almost twice” means a case where a gap between the guide section 13 and the display chassis 50 is sufficiently small to such an extent that it is possible for the guide section 13 to effectively receive external force which acts on the camera module 1 irrespective of the attachment posture that the camera module 1 takes between the first attachment posture and the second attachment posture.

Next, operational effects of the camera-module-attached electronic device 3 which is configured as mentioned above will be described.

In a case where the user wants to image a scene on the display surface side of the electronic device 2, first, the user grasps the camera module 1 in such a manner that the imaging surface side of the camera module 1 faces the display surface side of the electronic device 2 and the installation surface 12c confronts an upper surface of the upper vessel section 52a (see FIG. 5). Next, the user brings the installation surface 12c closer to the pad unit 60 from above while placing the guide surface 13a along a back surface of the rear plate section 53. In this case, relative positions of the mutually mating conduction pins 30 and conduction pads 61 in the depth direction Y are defined by bringing the guide surface 13a into contact with the back surface of the rear plate section 53. In addition, relative positions of the camera module 1 and the electronic device 2 in the crosswise direction X are roughly defined with the aid of the suction force (the magnetic force) which acts between the mutually mating fixing member 40 and device-side fixing member 80. Thereby, it becomes possible for the user to smoothly guide each conduction pin 30 to a position that each conduction pin 30 confronts each conduction pad 61 in the vertical direction Z. In a case where the user takes his/her hand off the camera module 1 in a state of bringing the installation surface 12c sufficiently close to the pad unit 60, the installation surface 12c abuts on or comes close to the upper vessel section 52a with the aid of the above-described magnetic force and each conduction pin 30 is pressed against each conduction pad 61. Accordingly, each conduction pin 30 and each conduction pad 61 are electrically connected with each other and it becomes possible to attach the camera module 1 to the electronic device 2 in the first attachment posture (see FIG. 7).

In a case where the user wants to image a scene on the back surface side of the electronic device 2, first, the user grasps the camera module 1 in such a manner that the imaging side of the camera module 1 faces the back surface side of the electronic device 2 and the installation surface 12c confronts the upper surface of the upper vessel section 52a. Next, the user brings the installation surface 12c closer to the pad unit 60 from above while placing the guide surface 13a along the display surface of the display chassis 50. After that, each conduction pin 30 and each conduction pad 61 are electrically connected with each other similarly to the case of the first attachment posture and thereby it becomes possible to attach the camera module 1 to the electronic device 2 in the second attachment posture (see FIG. 8).

In addition, in a case where the user wants to remove the camera module 1 from the electronic device 2, it is sufficient for the user to detach the camera module 1 from the electronic device 2 by grasping and then lifting the camera module 1 up. As described above, the camera module 1 is configured to be readily detachable relative to the electronic device 2.

As described above, the camera module 1 according to one embodiment of the present invention includes the imaging element 22, the main body unit 10 which houses the imaging element 22 and has the downward-facing installation surface 12c, the plurality of conduction pins 30 which protrudes from the installation surface 12c downward, is biased downward in the upward movable state and is arranged side by side in the crosswise direction X and at least one fixing member 40. In a case where the direction which is orthogonal to both the vertical direction Z and the crosswise direction X is defined as the depth direction Y, the side that the imaging element 22 faces in the depth direction Y is defined as the imaging side and the side which is opposite to the imaging side is defined as the non-imaging side, the main body unit 10 has the guide section 13 which is arranged closer to the non-imaging side than the plurality of conduction pins 30 and protrudes from the installation surface downward and the guide section 13 has the guide surface 13a which faces the imaging side.

It is possible to attach the camera module 1 which is configured in this way to the electronic device 2 from the outside. Thereby, it becomes possible to suppress the increases in thickness of the display chassis 50 in the depth direction Y and in width of the upper vessel section 52a in the vertical direction Z even in the case where the high-precision of the camera module 1 is realized in comparison with a case where the camera module 1 is built in the electronic device 2. In addition, since the conduction pins 30 are biased downward in the upward movable state, it becomes possible to electrically connect the electronic device 2 and the imaging element 22 with each other by pressing the conduction pins 30 against the corresponding conduction pads 61 respectively. In addition, since at least one fixing member 40 is arranged, it becomes possible to stably fix the camera module 1 and the electronic device 2 together with the aid of the magnetic force. Further, since the guide section 13 which protrudes from the installation surface 12c downward is installed on the main body unit 10, in a case where the camera module 1 is to be attached to the electronic device 2, it becomes possible for the user to determine the attachment position of the camera module 1 with ease by placing the guide section 13 along the display surface or the back surface of the electronic device 2. In addition, in a case where the external force acts on the camera module 1 in a state where the camera module 1 is attached to the electronic device 2, the guide section 13 receives the external force and thereby it becomes possible to suppress sudden falling of the camera module 1.

In addition, in the plurality of conduction pins 30, the conduction pins 30 which are arranged at mutually symmetric positions in the crosswise direction X have the mutually same functions. Owing to this configuration, even in a case where the camera module 1 is attached to the electronic device 2 in such a manner that the imaging element 22 faces either the display surface side or the back surface side of the electronic device 2, the function that each conduction pin 30 has is not changed when viewing from the electronic device 2 side. Accordingly, it becomes possible to readily change an imaging direction simply by turning the camera module 1 180 degrees around the vertical-direction-Z axis and then attaching the cameral module 1 to the electronic device 2.

In addition, the camera-module-attached electronic device 3 according to another embodiment of the present invention includes the electronic device 2 which has the display chassis 50 and the camera module 1 which is configured to be detachable relative to the electronic device 2 and has the imaging element 22. The electronic device 2 includes the pad unit 60 which is exposed to the upper surface of the display chassis 50 and that the plurality of conduction pads 61 is arranged side by side in the crosswise direction X and at least one device-side fixing member 80 which is arranged in the vicinity of the pad unit 60. The suction force (the magnetic force) is generated between the mutually mating device-side fixing member 80 and fixing member 40. The thickness L1 of the display chassis 50 in the depth direction Y is almost twice the mean value of the distance which is measured from the central axis line of each of the plurality of conduction pins 30 to the guide surface 13a in the depth direction Y. Owing to this configuration, even in the case where the cameral module 1 is attached to the electronic device 2 in such a manner that the imaging element 22 faces either the display surface side or the back surface side of the electronic device 2, it is possible to maintain the distance between the guide section 13 and the display chassis 50 almost constant. Accordingly, it becomes possible to make the guide section 13 function irrespective of the attachment posture of the camera module 1.

In addition, the display chassis 50 has the display 51 and the vessel 52 which surrounds the display 51 and is at least partially made of metal. Each conduction pad 61 has the shaft section 61b which extends in the vertical direction Z and the head section 61a which is located on the upper end of the shaft section 61b and is larger than the shaft section 61b in area when seen in the planar view and the insulation sheet 62a is arranged between the head section 61a and the vessel 52 and part of the shaft section 61b is covered with the insulation tube 62b. Owing to this configuration, it becomes possible to electrically insulate a circuit system which is configured by the imaging element 22, the FPC 70 in the display chassis 50 and so forth from a metal portion of the vessel 52 and to suppress intrusion of, for example, static electricity, noises and so forth into the circuit system via the vessel 52. Further, each insulation section 62 (the insulation sheet 62a and the insulation tube 62b) and each conduction pad 61 are formed separately from each other. For this reason, it becomes easy to make each insulation section 62 thin in comparison with, for example, a case where each conduction pad 61 and each insulation section 62 are integrally formed by the insert molding and so forth. Accordingly, it becomes possible to suppress an increase in depth-direction thickness of the display chassis 50 which is induced by an increase in thickness of each insulation section 62.

Incidentally, the technical scope of the present invention is not limited to the above-mentioned embodiments and it is possible to change the present invention in a variety of ways within the range not deviating from the gist of the present invention.

For example, although, in the above embodiments, it is described that the plurality of conduction pins 30 transmits and receives the electric signals in conformity to the USB standards, the camera module 1 may not conform to the USB standards.

In addition, although, in the above embodiments, the permanent magnets and iron are adopted as the materials of each fixing member 40 and each device-side fixing member 80 and the camera module 1 is attached to the electronic device 2 with the aid of the magnetic force, the technical scope of the present invention is not limited to use of the permanent magnets, iron and the magnetic force. For example, it is also possible to adopt hooks and so forth as each fixing member 40 and each device-side fixing member 80 and to attach the camera module 1 to the electronic device 2 by using fixing force other than the magnetic force.

In addition, although, in the above embodiments, the relative positions of the camera module 1 and the electronic device 2 in the crosswise direction are defined by using the permanent magnets as the materials of each fixing member 40 and each device-side fixing member 80 and then devising the polarity arrangements of the cameral module 1 and the electronic device 2, the technical scope of the present invention is not limited to the use of each fixing member 40 and each device-side fixing member 80. Specifically, the relative positions of the camera module 1 and the electronic device 2 in the crosswise direction X may be defined by utilizing members other than each fixing member 40 and each device-side fixing member 80 or using the other members in combination with the fixing members 40 and 80. For example, it is also possible to install a protrusion (for example, a rib) on the electronic device 2 and to define the relative positions of the camera module 1 and the electronic device 2 in the crosswise direction X by using the protrusion.

In addition, it is appropriately possible to replace the constitutional elements in the above-described embodiments with well-known constitutional elements within the range not deviating from the gist of the present invention and, in addition, the above-described embodiments may be appropriately combined with each other.

### DESCRIPTION OF SYMBOLS

1 . . . camera module, 2 . . . electronic device, 3 . . . camera-module-attached electronic device, 10 . . . main body unit, 12c . . . installation surface, 13 . . . guide section, 13a . . . guide surface, 22 . . . imaging element, 30 . . . conduction pin, 40 . . . fixing member, 50 . . . display chassis, 51 . . . display, 52 . . . vessel, 60 . . . pad unit, 61 . . . conduction pad, 61a . . . head section, 61b . . . shaft section, 62a . . . insulation sheet, 62b . . . insulation tube, 80 . . . device-side fixing member

1. A camera module comprising:
an imaging element;
a main body unit that houses the imaging element and has a downward-facing installation surface;
a plurality of conduction pins, protruding from the installation surface downward, that are biased downward in an upward movable state and are disposed side by side in a crosswise direction; and
at least one fixing member, wherein
in a case where a direction that is orthogonal to both a vertical direction and the crosswise direction is defined as a depth direction, the side that the imaging element faces in the depth direction is defined as the imaging side and the side that is opposite to the imaging side is defined as a non-imaging side,
the main body unit has a guide section that is disposed closer to the non-imaging side than the plurality of conduction pins and protrudes from the installation surface downward, and
the guide section has a guide surface that faces the imaging side.

2. The camera module according to claim 1, wherein
in the plurality of conduction pins, the conduction pins which are disposed at mutually symmetric positions in the crosswise direction have the mutually same functions.

3. A camera-module-attached electronic device comprising:
an electronic device which has a display chassis; and
a camera module that is detachable relative to the electronic device and has an imaging element, wherein
the electronic device includes:
a pad unit which is exposed to an upper surface of the display chassis and a plurality of conduction pads that is disposed side by side in a crosswise direction; and
at least one device-side fixing member,
the camera module includes:
a main body unit which houses the imaging element and has a downward-facing installation surface;
a plurality of conduction pins, protruding from the installation surface downward, that are biased downward in an upward-movable state and are disposed side by side in the crosswise direction; and
at least one fixing member which engages with the device-side fixing member,
in a case where a direction which is orthogonal to both a vertical direction and the crosswise direction is defined as a depth direction, the side that the imaging element faces in the depth direction is defined as the imaging side and the side that is opposite to the imaging side is defined as the non-imaging side,
the main body unit has a guide section that is disposed closer to the non-imaging side than the plurality of conduction pins and protrudes from the installation surface downward,
the guide section has a guide surface that faces the imaging side, and
a thickness of the display chassis in the depth direction is almost twice a mean value of a distance that is measured from a central axis line of each of the plurality of conduction pins to the guide surface in the depth direction.

4. The camera-module-attached electronic device according to claim 3, wherein
the display chassis has a display and a vessel which surrounds the display and is at least partially made of metal,
each of the conduction pads has a shaft section, extending in the vertical direction, and a head section that is disposed on an upper end of the shaft section and is larger in area than the shaft section when viewed in a planar view,
an insulation sheet is disposed between the head section and the vessel, and
part of the shaft section is covered with an insulation tube.
